(19) United States
(12) Patent Application Publication
(10) Pub. No.: US 2010/0118341 A1
(43) Pub. Date: May 13, 2010

(54) PRINTER TERMINAL AND POSTING SERVER

(75) Inventors: Takao Ozawa, Suwa-shi (JP); Kiyoshi Yoda, Suwa-shi (JP); Kazuyoshi Sato, Ueda (JP); Nobuaki Hanamura, Ueda (JP); Masaru Koda, Ueda (JP); Isamu Arai, Ueda (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/615,114

(22) Filed: Nov. 9, 2009

(30) Foreign Application Priority Data
Nov. 10, 2008 (JP) 2008-287676

(51) Int. Cl. G06F 3/12

(52) U.S. Cl. 358/1.15

(57) ABSTRACT

A printer terminal that is connected to a delivery system includes a posting server that delivers contents data for printing a content to the printer terminal through the network; and a relay server that relays setup of a session between the posting server and the printer terminal based on a delivery request from the posting server through the network by using a signaling protocol; through the network.

### BACKGROUND

1. Technical Field

The present invention relates to a technology for transmitting contents data, which is used for printing a content, through a network. In descriptions here, a “print content” or a “content” represents a document, an image, an information entity acquired by combining the document and the image, or the like that can be printed.

2. Related Art

Typically, when a company delivers an advertisement or the like to a customer, mail, a facsimile, or the like is used. In addition, in a field of distance learning or the like, when a text providing company delivers a text or the like to students, similarly, by the post, a facsimile, or the like is used.

When mailing is used, the print content such as an advertisement or a text that is printed at a high quality can be provided. However, in such a case, a lot of labor is involved in the delivery of the print content. Accordingly, there is a problem that a lot of cost is required, and a time is needed for delivering the print content.

In addition, when the facsimile is used, compared to a case where the post is used, less labor and time is required for the delivery of the print content. However, in such a case, there is a problem that communication costs incur, and the print content received from a client cannot be expected to have high quality. Furthermore, in the case where the facsimile is used, it can be checked whether the content has been received by a delivery destination. However, it cannot be checked whether the content is printed so as to be outputted.

On the other hand, recently, owing to the development of the Internet and the like, information can be transmitted at a low cost that is close to zero. In addition, owing to the development of a printer, a multifunction device, and the like that have high performance, high-quality printing can be performed at a relatively low cost also in houses.

In addition, as technology relating to transmission of information by using a network, for example, the technology has been disclosed in JP-A-2005-109701, JP-A-2003-178028, and JP-T-2005-516320.

Accordingly, the development of a system that can deliver the print content with high quality at a low cost by using a network such as the above-described Internet and a printer terminal that includes a printer, a multifunction device, or the like has been waited for.

In such a delivery system, it is extremely important for a person sending the print content to acquire whether the print content is assuredly delivered to the print terminal and whether the print content delivered to the printer terminal is printed.

### SUMMARY

An advantage of some aspects of the invention is that it provides technology for acquiring the delivery state and the printing state of the print content in a system in which the print content is delivered at a low cost with high quality.

According to a first aspect of the invention, there is provided a printer terminal that is connected to a delivery system including: a posting server that delivers contents data for printing a content to the printer terminal through the network; and a relay server that relays setup of a session between the posting server and the printer terminal based on a delivery request from the posting server through the network by using a signaling protocol; through the network. The printer terminal includes: a communication unit that accepts a session setup request through the relay server, sets up a session with the posting server, and acquires the contents data through a predetermined data transmission protocol by using the session that has been set up; a memory unit that stores the acquired content data and presence information including information that indicates the state of the contents data therein; and a printing unit that performs printing based on the contents data. The communication unit tries transmission of the presence information after update to the posting server when the state of the contents data that is included in the presence information is updated to indicate a reception-completed state or a state in which printing is completed by the printer unit, and does not accept a new session setup request from the posting server through the relay server when the amount of the presence information, which is included in the presence information after update, indicating non-completion of transmission to the posting server is equal to or larger than a predetermined value.

According to the above-described printer terminal, the posting sever that has delivered the print content to the printer terminal can assuredly acquire that the print content data has been delivered to the printer terminal, and printing of the print content in the printer terminal has been completed.

The above-described printer terminal may further include a data deleting unit that deletes the contents data stored in the memory unit. In the case, the communication unit transmits the presence information after update to the posting server when the state of the contents data that is included in the presence information is updated so as to indicate the completion of deletion.

In such a case, the posting server that has delivered the print content to the printer terminal can assuredly acquire that the print contents data has been deleted in the printer terminal.

In the above-described printer terminal, the communication unit may be configured to retry transmission for the posting server at a predetermined interval when there is the presence information after update of which the transmission for the posting server has not been completed.

In such a case, the presence information that has not been transmitted can be assuredly transmitted to the posting server.

In the above-described printer terminal, the signaling protocol may be configured to be an SIP (Session Initiation Protocol).

In the above-described printer terminal, the data transmission protocol may be configured to be an HTTP (Hypertext Transfer Protocol) or an HTTPS (Hypertext Transfer Protocol Security).

According to a second aspect of the invention, there is provided a posting server that delivers contents data for printing a content to a printer terminal and allows the printer terminal to perform printing based on the contents data. The posting server includes: a reception unit that receives the contents data and delivery destination information that are transmitted from the transmission terminal; a delivery unit that delivers the contents data, which has been received by the reception unit, based on a predetermined data transmission protocol by using a session that has been set up between the posting server and the printer terminal represented by the delivery destination information, which has been received by the reception unit, by using a relay server based on a signaling protocol; an acquisition unit that acquires presence information representing the delivery state and the printing state of the contents data, which have been delivered by the delivery unit, from the printer terminal of the delivery destination; and a providing unit that provides the transmission terminal with the presence information that has been acquired by the acquisition unit.

According to the above-described posting server, the posting server can provide the transmission terminal whether the print content data requested by the transmission terminal has been delivered to the printer terminal, and the print content has been printed by using the printer terminal.

In the above-described posting server, the delivery unit may be configured to deliver the contents data as a push type.

In addition, in the above-described posting server, the signaling protocol may be configured to be an SIP (Session Initiation Protocol).

### BRIEF DESCRIPTION OF THE DRAWINGS

The invention will be described with reference to the accompanying drawings, wherein like numbers reference like elements.

FIG. 1 is a schematic block diagram showing the configuration of a content delivery system as a first embodiment of the invention.

FIG. 2 is a block diagram showing a major configuration of a posting server.

FIG. 3 is a block diagram showing a major configuration of SIP servers.

FIG. 4 is an explanatory diagram showing the types of general SIP servers.

FIG. 5 is an explanatory diagram showing various forms of the configuration of printer terminals.

FIG. 6 is an explanatory diagram showing the sequence of the process for setting up a session between a posting server and a printer terminal.

FIG. 7 is a block diagram showing a major configuration of the printer terminal.

FIG. 8 is a diagram showing an example of the data structure of presence information.

FIG. 9 is a flowchart showing the process of the printer terminal for receiving contents data.

FIG. 10 is a flowchart showing a process for updating the presence information and a process for transmitting the presence information.

FIG. 11 is a flowchart showing a detailed process for transmitting a record for the presence information.

FIG. 12 is a sequence diagram schematically showing exchange of major data from delivery of a print content to delivery display.

### DESCRIPTION OF EXEMPLARY EMBODIMENTS

Hereinafter, a content delivery system according to an embodiment of the invention will be described with reference to the accompanying drawings.

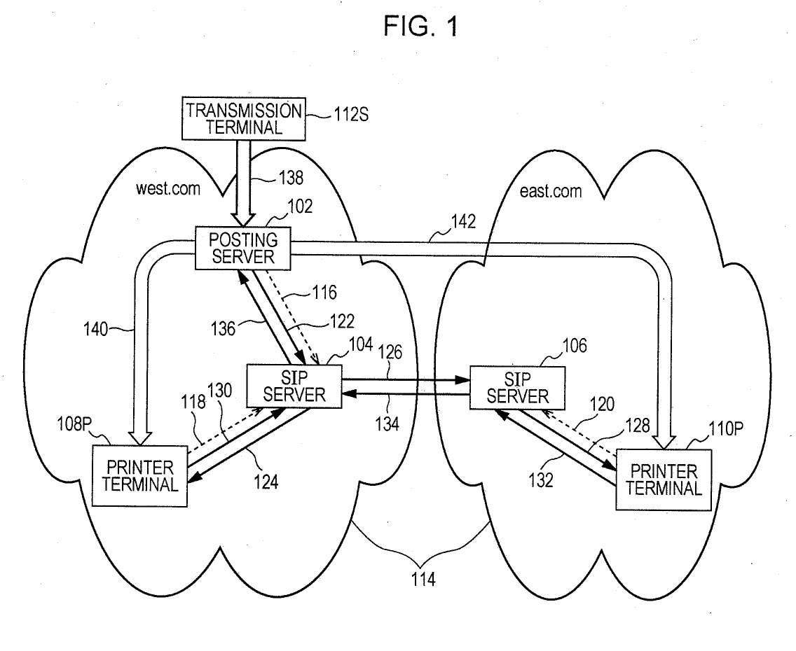

FIG. 1 is a schematic block diagram showing the configuration of the content delivery system according to this embodiment.

As shown in FIG. 1, the content delivery system according to this embodiment is configured by a transmission terminal 112S that is managed by a company that desires to deliver print contents (an advertisement, a text for distance learning, or the like), a posting server 102 and SIP (session initiation protocol) servers 104 and 106 that are managed by a network service provider, and printer terminals 108P and 110P that are managed by clients. The posting server 102 and the SIP servers 104 and 106 may be managed by different network service providers or a same network service provider. In addition, the posting server 102, the SIP servers 104 and 106, and the printer terminals 108P and 110P are interconnected through a so-called broadband network 114 including the Internet. The transmission terminal 112S may be connected to the posting server 102 through the same broadband network or may be connected to the posting server 102 through a dedicated line or the like.

In addition, as shown in FIG. 1, within the network 114, it is assumed that the posting server 102, the SIP server 104, and the printer terminal 108P belong to the domain of “west.com”, and the SIP server 106 and the printer terminal 110P belong to the domain of “east.com”.

In this embodiment, the print contents such as advertisement or a text for distance learning, to be described in detail later, is transmitted from the transmission terminal 112S to the posting server 102 as contents data and is delivered to the printer terminals 108P and 110P by the posting server 102 as a PUSH type. Here, as the contents data that is used for such a printing process, various types of data such as JPEG data, GIF data, PNG data, TIFF data, plain-text data, HTML data, PDF data, or PostScript (registered trademark) data that can be used for representing an image or a document can be used. In addition, when the model of the printer or the like that is used as the printer terminal is known, the contents data may be configured to be delivered in the format of print data. Here, the “PUSH type” means a method of delivering information in which the server side unilaterally transmits the information so as to be delivered to the terminal even when the terminal side does not request the information. In this embodiment, to be described later, the contents data is transmitted by using HTTP or HTTPS. Thus, two methods including a so-called push-type delivery method in which data is transmitted by accessing the printer terminals 108P and 110P from the posting server 102 (HTTP POST) and a so-called pull-type delivery method in which data is acquired by accessing the posting server 102 from the printer terminals 108P and 110P (HTTP GET) can be used.

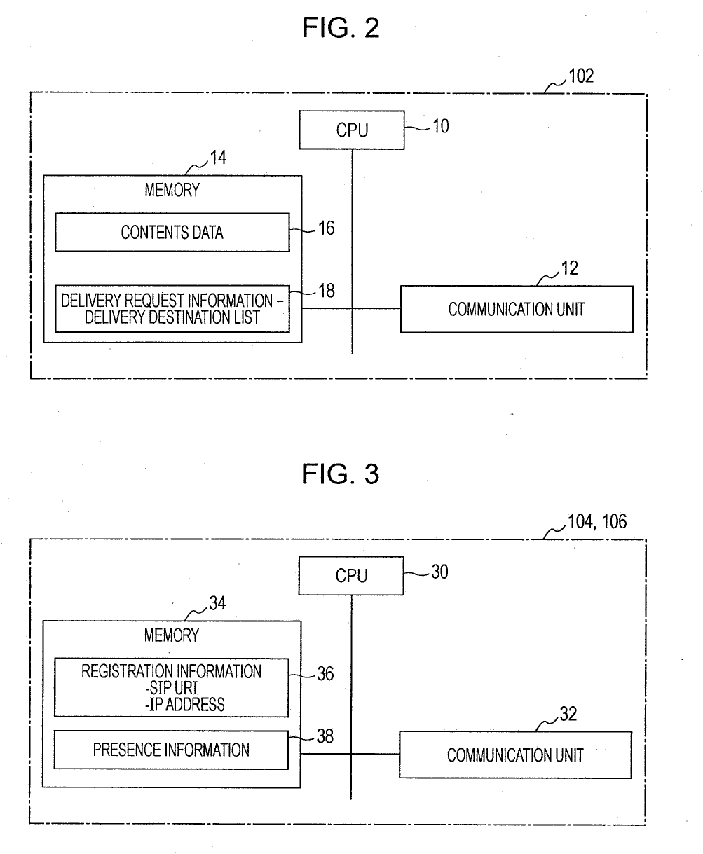

FIG. 2 is a block diagram showing a major configuration of the posting server 102 shown in FIG. 1. As shown in FIG. 2, the posting server 102 is configured by a server computer. The posting server 102 includes a CPU 10 that performs various processes and control operations by executing a program, a communication unit 12 that transmits various types of data, information, or the like to another device through a network, and a memory 14 that is used for storing a program, data, or information therein as its basic components. Among these, the memory 14 can store the contents data 16, delivery request information 18, or the like therein as data or information. In addition, the posting server 102 includes an input unit such as a keyboard or a pointing device, a display unit such as a monitor, or the like other than the above-described constituent elements, which are not shown in the figure.

In addition, in this embodiment, before the above-described delivery of the contents data, the setup of a session between devices is performed by using an SIP (session initiation protocol) that is one type of a signaling protocol. In addition, in this embodiment, an HTTP (hypertext transfer protocol) or an HTTPS (hypertext transfer protocol security), which is one type of a data transmission protocol, other than SIP is configured to be used for delivery of the contents data, that is, transmission of the contents data between devices. Here, a “session” is a relationship for transmitting or receiving media streams between nodes such as terminals.

FIG. 3 is a block diagram showing a major configuration of the SIP servers 104 and 106 shown in FIG. 1. As shown in FIG. 3, the SIP servers 104 and 106, similarly to the posting server 102, are configured by a server computer. The SIP servers 104 and 106 include a CPU 30 that performs various processes and control operations by executing a program, a communication unit 32 that transmits various types of data, information, or the like to another device through a network, and a memory 34 that is used for storing a program, data, or information therein as its basic components, respectively. Among these, the memory 34 can store registration information 36, presence information 38, or the like to be described later therein as information. In addition, the SIP servers 104 and 106 respectively include an input unit such as a keyboard or a pointing device, a display unit such as a monitor, or the like other than the above-described constituent elements, which are not shown in the figure.

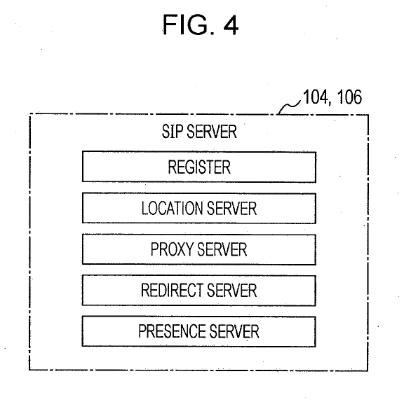

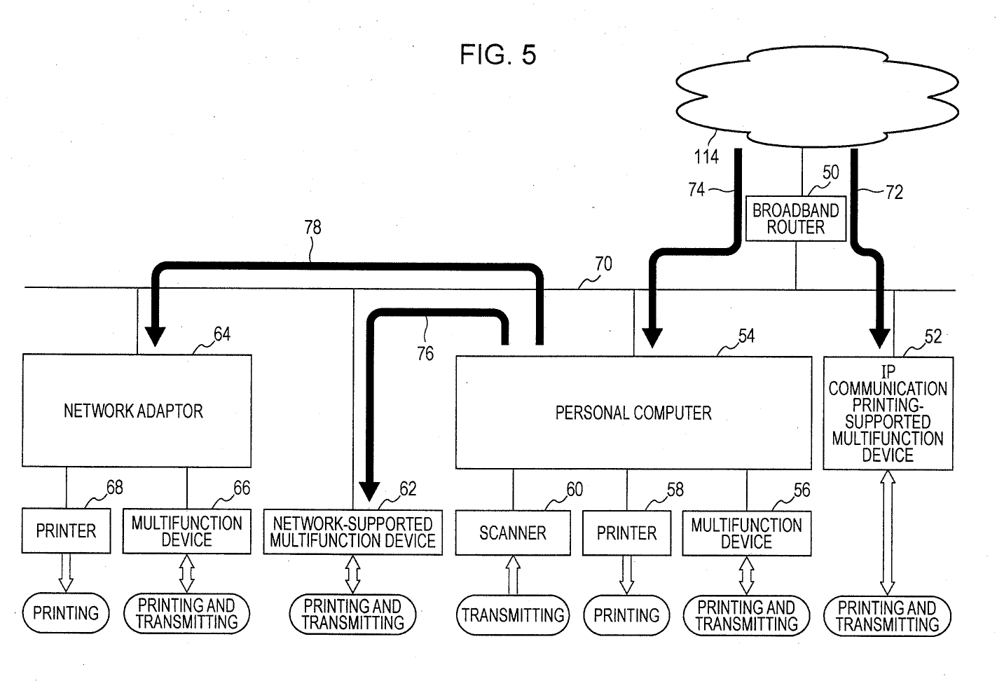

FIG. 4 is an explanatory diagram showing the types of general SIP servers. Generally, the SIP servers can be divided into the types shown in FIG. 4 based on the functions thereof.

A registrar accepts a registration request from an SIP client (that is, an SIP user agent) and registers the SIP address (that is, an SIP URI (uniform resource identifier)) or the positional information (that is, an IP (interne protocol) address or the like) of the SIP client in a location server.

The location server is a database for storing the SIP address, the positional information, or the like of the SIP client or the SIP server.

A proxy server is a server that relays a request or a response between the SIP clients. The proxy server relays session setup or the like between the SIP clients.

A redirect server notifies of the positional information of an opponent party desired to be communicated with, in response to an inquiry from the SIP client.

A presence server acquires and manages information on the state of the SIP client (for example, whether the power of the SIP client is turned on or off) and provides other SIP clients with the information as presence information.

FIG. 5 is an explanatory diagram showing various forms of the configuration of the printer terminals 108P and 110P shown in FIG. 1. As the configuration of the printer terminals 108P and 110P, as shown in FIG. 5, various forms may be considered to be used. Here, a multifunction device to be described later is a multiple-functional printing device that includes at least a printing function and a read-out and transmission function. In addition, a printer is a single-function printing device that includes at least a printing function.

In the first form, the printer terminal is configured only by an IP (internet protocol) communication printing-supported multifunction device 52. The IP communication printing-supported multifunction device 52 can directly handle a global address such as an SIP URI, to be described later. Thus, even when being directly connected to the broadband network 114 such as the Internet through the broadband router 50, the IP communication printing-supported multifunction device 52 can exchange data with devices on the network 114. Therefore, the printer terminal can be configured only by the IP communication printing-supported multifunction device 52. The delivered contents data, as denoted by a black arrow 72, is transmitted from the network 114 to the IP communication printing-supported multifunction device 52 through the broadband router 50. In addition, instead of the IP communication printing-supported multifunction device, an IP communication printing-supported printer may be configured to be used.

In the second faun, the printer terminal is configured by a personal computer 54 and a multifunction device 56 or a printer 58 that is directly connected to the personal computer 54 through a USB cable or the like. The delivered contents data, as denoted by a black arrow 74, is transmitted to the personal computer 54 through the broadband router 50 so as to be output to the multifunction device 56 or the printer 58.

In the third form, the printer terminal is configured by a personal computer 54 and a network-supported multifunction device 62 that is connected to the personal computer 54 through a LAN (local area network) 70 by using a LAN cable or the like. The network-supported multifunction device 62 cannot handle a global address but a private address. Accordingly, the network-supported multifunction device 62 cannot exchange data with devices on the network 114 without the personal computer 54 or the like interposed therebetween. The transmitted contents data, as denoted by the black arrow 74, is transmitted to the personal computer 54 through the broadband router 50 and then, as denoted by a black arrow 76, is transmitted to the network-supported multifunction device 62 through the LAN 70. In addition, instead of the network-supported multifunction device, a network-supported printer may be configured to be used.

In the fourth form, the printer terminal is configured by a personal computer 54, a network adaptor 64 that is connected to the personal computer 54 through a LAN 70 by using a LAN cable or the like, and a multifunction device 66 or a printer 68 that is connected to the network adaptor 64 by using a USB cable or the like. This form is effective when the multifunction device or the printer is not network-supported. The transmitted contents data, as denoted by a black arrow 74, is transmitted to the personal computer 54 through the broadband router 50 and then, as denoted by a black arrow 78, is transmitted to the network adaptor 64 through the LAN 70. Thereafter, the content data is output to the multifunction device 66 or the printer 68.

Here, instead of being connected together by using a wire such as a cable, the devices may be connected wirelessly by using a wireless LAN, Bluetooth, an infrared ray, or the like.

While a global IP address can be assigned on the network 114 including the Internet, a private IP address can be assigned on many private networks such as the LAN 70. In such a case, there is a so-called NAT (network address translation) traversal problem. However, as generally known, such a problem can be solved by using UPnP (Universal Plug and Play) technology, STUN (Simple Traversal of UDP through NAT) technology, TURN (Traversal Using Relay NAT) technology, ICE (Interactive Connectivity Establishment) technology, or the like as an NAT traversing method.

The multifunction device has the read-out and transmission function, as described above. Thus, when the multifunction device is used, the multifunction device may configure not only the printer terminal but also a transmission terminal. Alternatively, a form in which the transmission terminal is configured by a personal computer 54 and a scanner 60 that is directly connected to the personal computer 54 by using a USB cable or the like may be considered to be used. When the transmission terminal is configured, the read-out and transmitted contents data is transmitted to the network 114 following a path formed in a direction opposite to the above-described black arrow. The SIP servers 104 and 106 in this embodiment correspond to a relay server according to an embodiment of the invention.

In this embodiment, as described above, the setup of a session between devices is performed by using the SIP that is one type of the signaling protocol, and transmission of the contents data between the devices is performed by using the HTTPS that is one type of the data transmission protocol. Hereinafter, the overview of the operation of the contents delivery system in this embodiment will be described.

As shown in FIG. 1, first, when getting started, the posting server 102 and the printer terminal 108P access the SIP server 104 that belongs to the same domain (west.com) as SIP clients. Similarly, when getting started, the printer terminal 110P also accesses the SIP server 106 that belongs to the same domain (east.com) as an SIP client. Then, the positing server 102 and the printer terminals 108P and 110P, as denoted by broken arrows 116, 118, and 120, output registration requests to the accessed SIP servers 104 and 106 and transmit information such as the SIP URI or the IP address thereof. The SIP servers 104 and 106 serve as registrars and location servers, and, as shown in FIG. 3, the CPU 30 accepts the registration request through the communication unit 32 and registers the transmitted information in the memory 34 as the registration information 36.

As a result, the SIP sever 104 has the registration information on the posting server 102 and the printer terminal 108P that belong to the same domain (west.com) as that of the SIP server 104, and the SIP server 106 has the registration information of the printer terminal 110P that belongs to the same domain (east.com) as that of the SIP sever 106. In the registration information 36, the SIP URI and the IP address are associated with each other for each terminal, and the registration information 36 is managed by the CPU 30.

Here, for example, the SIP URI is denoted by an identifier in the format of “sip:user@west.com”. In the format, at the beginning, an identifier (scheme) that indicates a SIP is placed (“sip”). Next, a user identifier is placed (“user”), and a host name is placed (“west.com”) with being demarcated by “@”. In addition, as the user identifier, a user ID, a telephone number, or the like is used. As the host name, an FQDN (Fully Qualified Domain Name) or an IP address is used. Furthermore, a port number, an option parameter, or the like may be configured to be placed after the host name. In addition, instead of the SIP URI, an SIPS URI that is a secured URI of the SIP may be used. In such a case, “sips” is placed as the scheme.

When a prior preparation process for the SIP is completed as described above, delivery of the contents data can be performed by using the SIP.

First, the entity data of one or more print contents desired to be delivered as the print contents and the list of delivery destinations are prepared on the company side. The transmission terminal 112S transmits the contents data that includes one entity data or more and delivery request information that includes the list of the delivery destinations to the positing server 102 as denoted by a white arrow 138. The posting server 102 temporarily stores the received contents data 16 and the delivery request information 18 in the memory 14, as shown in FIG. 2. At this moment, API (Application Program Interface) technology is used for transmission of the contents data and the delivery request information from the transmission terminal 112S to the posting server 102. As the transmission protocol, the HTTPS is used. However, a different data transmission protocol such as an FTP (File Transfer Protocol) may be configured to be used as the transmission protocol.

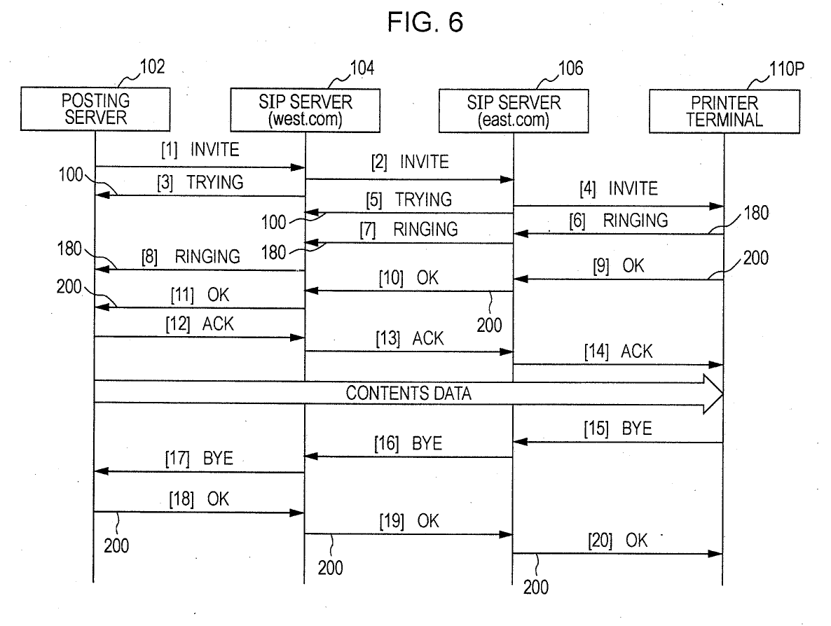

The CPU 10 of the posting server 102 reads out the delivery request information 18 and analyzes the list of the delivery destinations included therein. In the list of the delivery destinations, the SIP URI of the printer terminal 108P or 110P is written as the delivery destination. Then, the CPU 10 of the posting server 102, first, transmits a request to the SIP server 104 that belongs to the same domain (west.com) as that of the posting server 102 with the printer terminal 110P designated as a delivery destination based on the list of the delivery destinations (a solid-line arrow 122). At this moment, the SIP server 104 serves as a proxy server. Since the printer terminal 110P belongs to the domain (east.com) that is different from that of the SIP server 104, the SIP server 104 does not have the registration information on the printer terminal 110P. Thus, the SIP server 104 transmits the request to the SIP server 106 that belongs to the same domain (east.com) as that of the printer terminal 110 (a solid-line arrow 126). The SIP server 106 also serves as a proxy server. Since the printer terminal 110P belongs to the same domain (east.com) as that of the SIP server 106, the SIP server 106 has the registration information on the printer terminal 110P. Accordingly, the SIP server 106 relays the transmitted request to the printer terminal 110P based on the registration information (a solid-line arrow 128). The printer terminal 110P transmits the response for the request to the SIP server 106 with the posting server 102 designated as a reply destination (a solid-line arrow 132). Then, since the posting server 102 belongs to the domain (west.com) that is different from that of the SIP server 106, the SIP server 106 does not have the registration information on the posting server 102. Accordingly, the SIP server 106 transmits the response to the SIP server 104 that belongs to the same domain (west.com) as that of the posting server 102 (a solid-line arrow 134). Since the posting server 102 belongs to the same domain (west.com) as that of the SIP server 104, the SIP server 104 has the registration information on the posting server 102. Accordingly, the SIP server 104 relays the transmitted response to the posting server 102 based on the registration information (a solid-line arrow 136). As described above, by exchanging the request and the response between the posting server 102 and the printer terminal 110P, a session between both parties is set up. At this moment, both the SIP servers 104 and 106 relay the setup of the session by serving as proxy servers. Described in more details, the request and the response as shown in FIG. 6 are exchanged.

FIG. 6 is an explanatory diagram showing the sequence of the process for setting up a session between the posting server 102 and the printer terminal 110P shown in FIG. 1. In FIG. 6, time flows from the upper side to the lower side. In addition, the process sequence advances in the order of the numbers enclosed with brackets.

The posting server 102, in order to deliver its IP address to the printer terminal 110P, has the IP address of the posting server 102 to be included in the body of an INVITE request message that is to be transmitted to the printer terminal 110P. Meanwhile, the printer terminal 110P, in order to deliver its IP address to the posting server 102, also has the IP address of the printer terminal 110P to be included in the body of a 200 OK response message that is to be transmitted to the posting server 102.

Accordingly, when an ACK request message that has been transmitted from the posting server 102 reaches the printer terminal 110, the session between the posting server 102 and the printer terminal 110P is set up.

Thereafter, the posting server 102 directly accesses the printer terminal 110P without being mediated by the SIP servers 104 and 106 based on the IP address of the printer terminal 110P that has been acquired from the 200 OK response message and delivers the contents data through HTTPS as the PUSH type, as denoted by the white arrow 142 shown in FIG. 1.

When completing receiving the delivered contents data, the printer terminal 110P transmits a BYE request message to the posting server 102 through the SIP servers 104 and 106 in accordance with the SIP. When receiving the BYE request message, the posting server 102 returns the 200 OK response message to the printer terminal 110P through the SIP servers 104 and 106. Accordingly, the session formed between the posting server 102 and the printer terminal 110P is cleared.

Next, the CPU 10 of the posting server 102 transmits a request to the SIP server 104 with the printer terminal 108P that belongs to the same domain (west.com) as that of the posting server 102 designated as a delivery destination based on the list of the delivery destinations (a solid-line arrow 122). Since the printer terminal 108P belongs to the same domain (west.com) as that of the SIP server 104, the SIP server 104 has the registration information on the printer terminal 108P. Accordingly, the SIP server 104 relays the request to the printer terminal 108P based on the registration information (a solid-line arrow 124). The printer terminal 108P transmits the response for the request to the SIP server 104 with the posting server 102 designated as the reply destination (a solid-line arrow 130). Then, since the posting server 102 belongs to the same domain (west.com) as that of the SIP server 104, the SIP server 104 has the registration information on the posting server 102. Accordingly, the SIP server 104 relays the response to the posting server 102 based on the registration information (a solid-line arrow 136). As described above, by exchanging the request and the response between the posting server 102 and the printer terminal 108P, a session between both parties is set up. At this moment, the SIP server 104 relays the setup of the session by serving as a proxy server. In addition, since the sequence of the process for setting up a session between the posting server 102 and the printer terminal 108P can be easily acquired on the analogy of the above-described FIG. 6, a description thereof is omitted here.

When the session between the posting server 102 and the printer terminal 108P is set up as described above, the posting server 102 directly accesses the printer terminal 108P without being mediated by the SIP server 104 based on the IP address of the printer terminal 108P and delivers the contents data through HTTPS as the PUSH type, as denoted by the white arrow 140 shown in FIG. 1.

When the delivery of the contents data is completed, the posting server 102 and the printer terminal 108P exchange a BYE request message and a 200 OK response message. Accordingly, the session formed between the posting server 102 and the printer terminal 108P is cleared.

The printer terminals 108P and 110P perform printing by using the printing function based on the delivered contents data, whereby outputting the print contents. Accordingly, the print contents can be delivered to clients who manage the printer terminals 108P and 110P.

On the other hand, the SIP servers 104 and 106 serve as presence servers. The CPU 30 of the SIP server 104 acquires the presence information on the state of the printer terminal 108P belonging to the same domain (west.com) through the communication unit 32, and the CPU 30 of the SIP server 106 acquires the information on the state of the printer terminal 110P belonging to the same domain (east.com) through the communication unit 32. Then, as shown in FIG. 3, the CPUs 30 of the SIP servers 104 and 106 store the acquired presence information in the memory 34 as presence information 38 and manage the presence information 38. The presence information 38 on the printer terminals 108P and 110P that belong to the domains of the SIP servers 104 and 106 may be configured to be exchanged between the SIP servers 104 and 106. Then, the CPUs 30 of the SIP servers 104 and 106 provide the posting server 102 the presence information 38. Accordingly, the posting server 102 can acquire the states of the printer terminals 108P and 110P.

According to the above-described embodiment, the network 114 that includes the Internet is used for transmission of the contents data. Accordingly, the contents data can be delivered at a low cost and a high speed. In addition, since a client's high-performance printer or multifunction device can be used as the printer terminal, high-quality printing can be performed. Furthermore, by using the posting server 102, the company side only needs to prepare the contents data desired to be delivered as the print content and the list of the delivery destinations, whereby the required human resources and economic costs are decreased. In addition, by using the posting server 102, a large amount of the print content can be delivered. Furthermore, as the posting server 102 delivers the contents data as the PUSH type, the client can automatically receive the print content without awareness of anything.

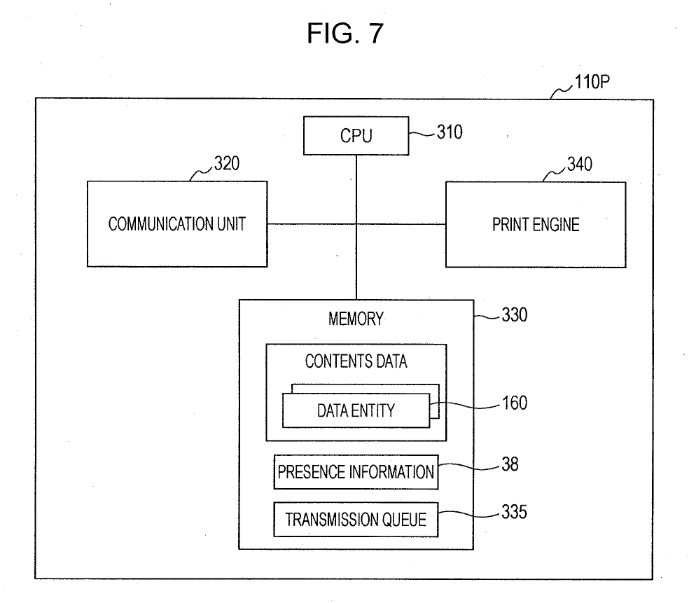

FIG. 7 is a block diagram showing a major configuration of the printer terminal 110P. Here, although the printer terminal 110P is described as an example, the printer terminal 108 may also have the same configuration as the printer terminal 110P. In FIG. 7, the printer terminal 110P is described as a multifunction device such as the IP communication printing-supported multifunction device 52 or the network-supported multifunction device 62 that can be directly connected to the network as an example. However, even when the printer terminal 110P is configured by the multifunction device 66 or the printer 68 that is connected to the network through the network adaptor 64 or is configured by the personal computer 54, the printer 58, the multifunction device 56, or the like, the same configuration can be substantially implemented.

The printer terminal 110P includes a CPU 310 that performs various processes and control operations by executing programs, a communication unit 320 that performs transmission of various types of data, information, or the like to other devices through a network, a memory 330 that is used for storing a program, data, or information therein, and a print engine 340 that includes a print head, a paper feed mechanism, and the like and performs printing, as its basic components. Among these, the memory 330 can store the contents data 16 delivered from the posting server 102 and the presence information 38 of the contents data 16 therein. In addition, a transmission queue 335 is arranged on the memory 330.

Furthermore, the printer terminal 110P includes an input-output unit such as an operation panel other than the above-described constituent elements, which is not shown in the figure.

The communication unit 320 accepts a session setup request from the posting server 102 through the SIP servers 106 and 104 and sets up a session between the posting server 102 and the printer terminal. In addition, the communication unit 320 acquires the contents data 16 (data entity 160) through the HTTP or the HTTPS from the posting server 102 by using the set up session and stores the contents data in the memory 330.

The contents data 16 is configured by a plurality of data entities 160, 160, . . . corresponding to individual print contents.

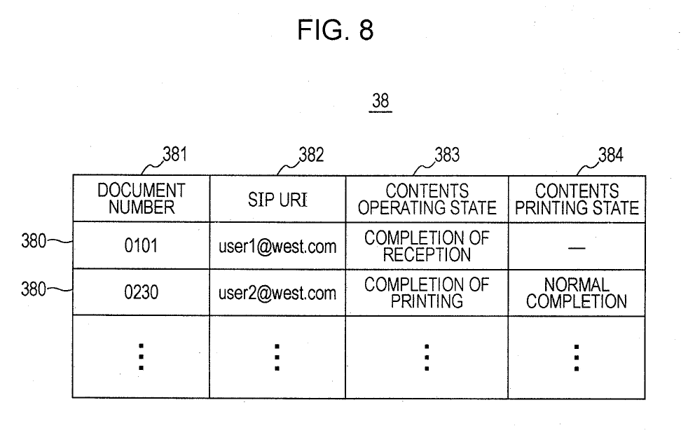

The presence information 38 includes information that represents the attributes of each data entity 160, 160, . . . . For example, in the presence information 38, as shown in FIG. 8, a document number 381 that is identification information of each data entity 160, 160, . . . , a SIP URI 382 that is identification information of the posting server 102 of the transmission source, a contents operating state 383 that represents the state of each data entity 160, 160, . . . and a contents printing state 384 that represents the printing state of each data entity 160, 160, . . . are included as data items. In the presence information 38, one record 380 is configured for one data entity 160. In other words, in the presence information 38, a plurality of records 380, 380, . . . corresponding to a plurality of data entities 160, 160, . . . is included.

For example, the contents operating state 383 may take a “reception-completed state” that indicates completion of the reception (delivery) of the data entity 160, a “printing-completed state” that indicates completion of printing, a “deletion-completed state” that indicates the completion of deletion of the data entity 160 from the memory 330, and the like. In addition, the contents printing state 383, for example, may take “normal completion” that indicates that the printing has been normally completed, “cancel” that indicates that the printing has been canceled in the middle of the process by a user, an “abnormal completion” indicates that the printing has not been normally completed due to an error of the printer or the like, and the like.

When the CPU 310 executes predetermined programs, a management unit that manages the presence information 38, a deletion unit that deletes the data entity 160 from the memory 330, and the like are implemented. For example when the communication unit 320 stores the received data entity 160 in the memory 330, the CPU 310, serving as the management unit, updates the contents operating state 383 of the record 380 for the presence information 38 corresponding to the data entity 160 to the “reception-completed state”. In addition, when the print engine 340 performs printing based on the data entity 160, the CPU 310 serving as the management unit acquires the status of the printing from the print engine 340 and updates the record 380 for the presence information 38 corresponding to the printed data entity 160. For example, when printing of a specific data entity 160 is normally completed, the contents operating state 383 of the record 380 corresponding to the presence information 38 is updated to the “printing-completed state”, and the contents printing state 383 is updated to the “normal completion”. On the other hand, when the CPU 310 serving as the deletion unit deletes the data entity 160 from the memory 330, the CPU 310 serving as the management unit updates the contents operating state 383 of the record 380 for the presence information 38 corresponding to the deleted data entity 160 to the “deletion-completed state” in accordance with the deletion.

For example, the CPU 310 serving as the deletion unit may be configured to delete the data entity 160 from the memory 330 when receiving a direction from a user. Alternatively, it may be configured that an effective period from the delivery time is set for each data entity 160 in advance, and the CPU 310 serving as the deletion unit automatically deletes each data entity 160 when the effective period of the data entity 160 elapses.

When any item of the record 380 in which the presence information 38 is included is updated, the CPU 310 serving as the management unit stores the record 380, in which the presence information 38 after update is included, in the transmission queue 335. For example, the CPU 310 may be configured to store the record 380, in which the presence information 38 after update is included, in the transmission queue 335 in a case where the contents operating state 383 is updated, particularly where the contents operating state 383 becomes the “reception-completed state”, the “printing-completed state”, or the “deletion-completed state”.

The communication unit 320 tries to transmit the record 380 for the presence information 38 that is stored in the transmission queue 335 to the posting server 102. The communication unit 320 may be configured to transmit the record 380 for the presence information 38, for example, by using the TCP or the UDP. The posting server 102 located at the delivery destination, for example, is determined based on the SIP URI 382 of the presence server 102 that is included in the transmitted record 380 for the presence information 38. When transmission of the record 380 for the presence information 38 to the posting server 102 cannot be completed for some reason or other, the communication unit 320 waits for a predetermined time and then retries the transmission of the record 380 for the presence information 38 that remains in the transmission queue 335. After a complete transmission of the record 380 of the presence information 38 to the presence server 120, the record is deleted from the transmission queue 335. The determination on whether the transmission has been completed, for example, may be configured to be performed based on whether the notification of reception of the record 380 for the presence information 38 has been received from the posting server 102.

In a case where the records 380 for the presence information 38 equal to or more than a predetermined number are accumulated in the transmission queue 335, even when there is a new session setup request from the presence server 102, the communication unit 320 denies the request. There is need to assuredly transmit the record 380 for the presence information 38 to the presence server 102. Accordingly, when the record 380 for the presence information 38 that has not been transmitted is increased, a new data entity 160 is not accepted.

Next, the process of the printer terminal 110P having the above-described configuration will be described with reference to a flowchart.

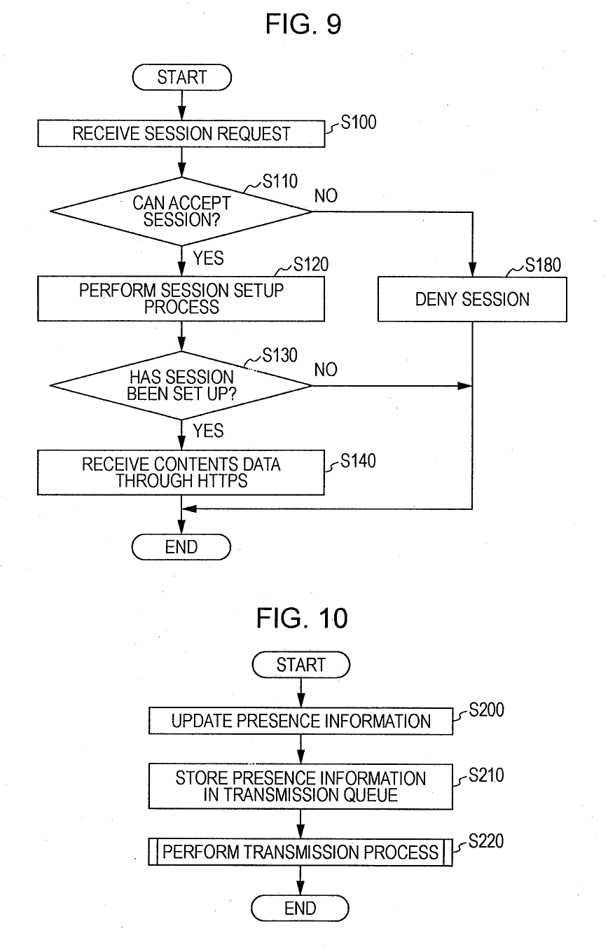

FIG. 9 is a flowchart showing the process of the printer terminal 110P for receiving the contents data 16.

First, the communication unit 320 accepts a session setup request from the posting server 102 through the SIP servers 104 and 106 (S100). Here, the communication unit 320 determines whether the session setup request can be accepted (S110). For example, in a case where the session setup request is not to be accepted (S110: No) such as a case where the records 380 for the presence information 38, which have not been transmitted, equal to or more than the predetermined number are stored in the transmission queue 335, the communication unit 320 denies the session setup request (S180).

On the other hand, in a case where the session setup request is accepted by the communication unit 320 (S110: Yes), the communication unit 320 performs a predetermined session setup process between the posting server 102 and the printer terminal 110P (S120). Then, when the session is set up between the printer terminal 110P and the posting server 102 (S130: Yes), the communication unit 320 receives the data entity 160 of the contents data 16 transmitted from the posting server 102 by using the HTTPS (S140).

As described above, when the records 380 for the presence information 38, which have not transmitted, equal to or more than the predetermined number are stored in the transmission queue 335, the printer terminal 110P denies the session setup request from the posting server 102. Accordingly, it can be prevented that the records 380 for the presence information 38, which have not been transmitted, are increased too much in the posting server 102, whereby a trouble such as a loss of a record that has not been transmitted is prevented in advance.

Next, FIG. 10 is a flowchart showing a process for updating the presence information and a process for transmitting the presence information.

When detecting the state change in the data entity 160, the CPU 310 updates the record 380 for the presence information 38 corresponding to the data entity 160 (S200). For example, when the record 380 for the presence information 38 is updated as the data entity 160 delivered from the posting server 102 is received or printing on the basis of the data entity 160 is completed, the CPU 310 detects the update of the record 380 for the presence information 38.

Then, the CPU 310 reads out the updated record 380 for the presence information 38 from the memory 330 and stores the updated record 380 in the transmission queue 335 (S210).

When the record 380 for the presence information 38 is stored in the transmission queue 335, the communication unit 320 transmits the record 380 for the presence information 38 that is stored in the transmission queue 335 (S220). Accordingly, the updated record 380 for the presence information 38 is immediately started to be transmitted to the posting server 102. This transmission process will be described in detail as below.

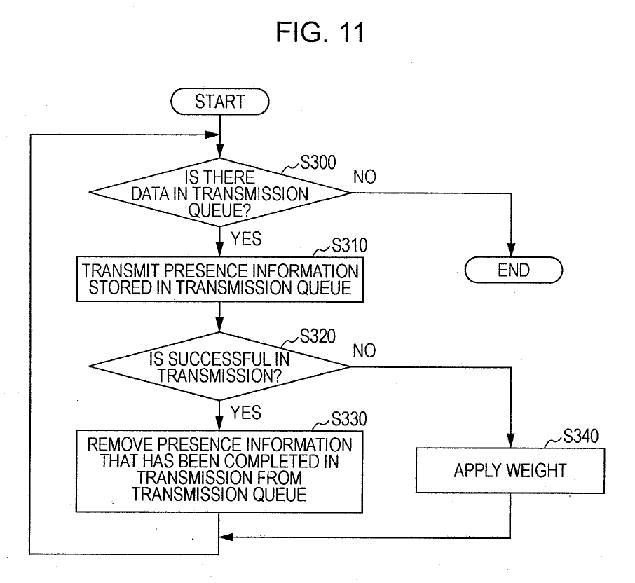

FIG. 11 is a flowchart showing a detailed process for transmitting the record 380 for the presence information 38.

The communication unit 320 determines whether one or more records 380 for the presence information 38 that have not been transmitted is stored in the transmission queue 335 (S300). When there is no record 380 for the presence information 38, which have not been transmitted, in the transmission queue 335 (S300: No), the communication unit 320 completes this process.

On the other hand, when there are the records 380 for the presence information 38, which have not been transmitted, in the transmission queue 335 (S300: Yes), the communication unit 320 tries to transmit the records 380 for the presence information 38, which have not been transmitted, to the posting server 102 sequentially from the beginning of the transmission queue 335 (S310):

After performing the above-described transmission, the communication unit 320 determines whether the transmission of the records to the posting server 102 has been successful (S320).

When the transmission of the record 380 for the presence information 38 to the posting server 102 has been successful (S320: Yes), the communication unit 320 deletes the transmission-completed records 380 from the transmission queue 335 (S330). On the other hand, when the transmission of the record 380 for the presence information 38 has failed (S330: No), the communication unit 320 waits for a predetermined time and repeats Step S310 and the following processes thereof (S340).

Accordingly, the record 380 for the presence information 38 that is accumulated in the transmission queue can be transmitted to the posting server 102.

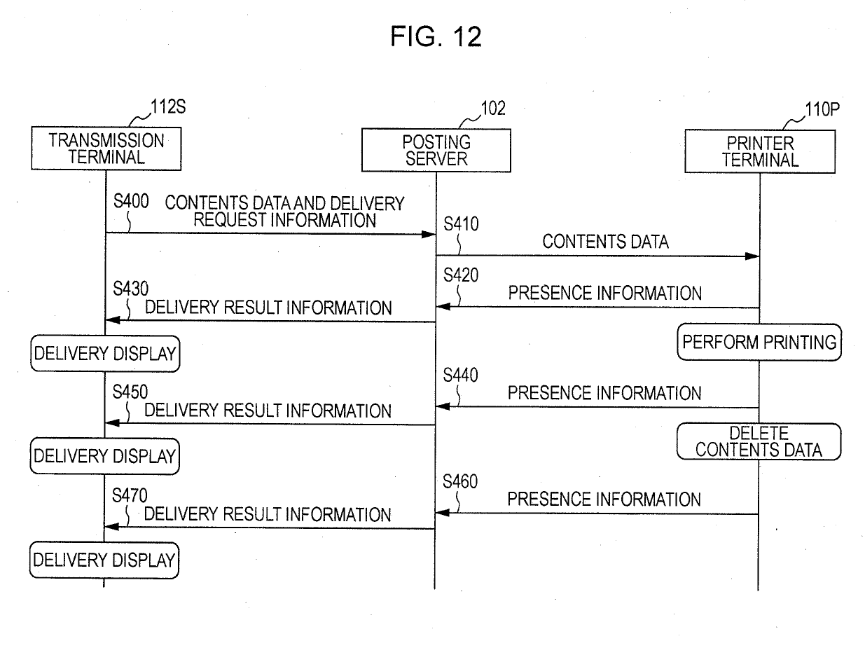

Next, FIG. 12 is a sequence diagram schematically showing exchange of major data until delivery display for checking whether a print content is delivered and printed is performed after the delivery of the print content is requested by a transmission terminal 112S. The exchange of data will now be described with reference to the figure. In the figure, the SIP servers 104 and 106, the process for setting up a session, and the like are omitted.

First, the request terminal 112S transmits the data entity 160 and delivery request information of the print content to the posting server 102 (S400). The communication unit 12 of the posting server 102 receives the contents data and the delivery request information.

The posting server 102 determines a printer terminal 110P, which is the delivery destination, based on the delivery request information and the communication unit 12 delivers the contents data to the printer terminal 110P through the SIP servers 104 and 106 by using a setup session (S410).

When receiving the data entity 160, as described above, the printer terminal 110P transmits the record 380 for the presence information 38 corresponding to the data entity 160 to the posting server 102 (S430). The communication unit 12 of the posting server 102 acquires the record 380 for the presence information 38 that has been transmitted from the printer terminal 110P.

The posting server 102 provides the transmission terminal 112S delivery result information that represents the completion of delivery of the data entity 160 based on the record 380 for the presence information 38 that is acquired by the communication unit 12 (S440). Then, the transmission terminal 112S performs delivery display that represents the status of the content requested to be printed based on the provided delivery result information. Accordingly, it can be acquired that the print content requested to be delivered by the transmission terminal 112S has been delivered to the printer terminal 110P.

Meanwhile, the printer terminal 110P prints the received data entity 160. Then, when completing the printing, the printer terminal 110P transmits the record 380 for the presence information 38 corresponding to the data entity 160 to the posting server 102 (S450). The communication unit 12 of the posting server 102 acquires the record 380 for the presence information 38 that has been transmitted from the printer terminal 110P.

The posting server 102 provides the transmission terminal 112S the delivery result information representing completion of printing the data entity 160 based on the record 380 for the presence information 38 that is acquired by the communication unit 12 (S460). Then, the transmission terminal 112S performs the delivery display based on the provided delivery result information. Accordingly, it can be acquired that the print content requested to be transmitted by the transmission terminal 112S has been printed by using the printer terminal 110P.

In addition, when the data entity 160 is deleted, the printer terminal 110P transmits the record 380 for the presence information 38 corresponding to the data entity 160 to the posting server 102 (S470). The communication unit 12 of the posting server 102 acquires the record 380 for the presence information 38 that has been transmitted by the printer terminal 110P.

The posting server 102 provides the transmission terminal 112S the delivery result information representing the completion of deletion of the data entity 160 based on the record 380 for the presence information 38 that has been acquired by the communication unit 12 (S480). Then, the transmission terminal 112S performs the delivery display based on the delivery result information. Accordingly, it can be acquired that the print content requested to be delivered by the transmission terminal 112S has been deleted in the printer terminal 110P.

As described above, by providing the transmission terminal the delivery result information, a company or the like that has requested to deliver the print content can be notified that the print content has been delivered to the printer terminal or the print content has been printed.

The above-described embodiment of the invention is an example for describing the invention and is not for the purpose of limiting the scope of the invention to such an embodiment. Those skilled in the art may perform the invention in various forms without departing from the gist of the invention.

What is claimed is:

1. A printer terminal that is connected to a delivery system including: a posting server that delivers contents data for printing a content to the printer terminal through the network; and a relay server that relays setup of a session between the posting server and the printer terminal based on a delivery request from the posting server through the network by using a signaling protocol; through the network, the printer terminal comprising:
a communication unit that accepts a session setup request through the relay server, sets up a session with the posting server, and acquires the contents data through a predetermined data transmission protocol by using the session that has been set up;
a memory unit that stores the acquired content data and presence information including information that indicates the state of the contents data therein; and
a printing unit that performs printing based on the contents data,
wherein the communication unit tries transmission of the presence information after update to the posting server when the state of the contents data that is included in the presence information is updated to indicate a reception-completed state or a state in which printing is completed by the printer unit, and does not accept a new session setup request from the posting server through the relay server when the amount of the presence information, which is included in the presence information after update, indicating non-completion of transmission to the posting server is equal to or larger than a predetermined value.

2. The printer terminal according to claim 1, further comprising a data deleting unit that deletes the contents data stored in the memory unit,
wherein the communication unit transmits the presence information after update to the posting server when the state of the contents data that is included in the presence information is updated so as to indicate the completion of deletion.

3. The printer terminal according to claim 1, wherein the communication unit retries transmission for the posting server at a predetermined interval when there is the presence information after update of which the transmission for the posting server has not been completed.

4. The printer terminal according to claim 1, wherein the signaling protocol is an SIP (Session Initiation Protocol).

5. The printer terminal according to claim 1, wherein the data transmission protocol is an HTTP (Hypertext Transfer Protocol) or an HTTPS (Hypertext Transfer Protocol Security).

6. A posting server that delivers contents data for printing content to a printer terminal and allows the printer terminal to perform printing based on the contents data, the posting server comprising:
a reception unit that receives the contents data and delivery destination information that are transmitted from the transmission terminal;
a delivery unit that delivers the contents data, which has been received by the reception unit, based on a predetermined data transmission protocol by using a session that has been set up between the posting server and the printer terminal represented by the delivery destination information, which has been received by the reception unit, by using a relay server based on a signaling protocol;
an acquisition unit that acquires presence information representing the delivery state and the printing state of the contents data, which have been delivered by the delivery unit, from the printer terminal of the delivery destination; and
a providing unit that provides the transmission terminal with the presence information that has been acquired by the acquisition unit.

7. The posting server according to claim 6, wherein the delivery unit delivers the contents data as a push type.

8. The posting server according to claim 6, wherein the signaling protocol is an SIP (Session Initiation Protocol).
